(19) United States
(12) Patent Application Publication
(10) Pub. No.: US 2008/0052349 A1
(43) Pub. Date: Feb. 28, 2008

(54) Methods and System for Aggregating Disparate Batches of Digital Media Files Captured During an Event for the Purpose of Inclusion into Public Collections for Sharing

(76) Inventor: Michael Lin, Tokyo (JP)

Correspondence Address: CENTRAL COAST PATENT AGENCY, INC, 3 HANGAR WAY SUITE D, WATSONVILLE, CA, 95076, US

(21) Appl. No.: 11/845,235

(22) Filed: Aug. 27, 2007

Related U.S. Application Data
(60) Provisional application No. 60/823,659, filed on Aug. 27, 2006.

(51) Int. Cl. G06F 9/46; G06F 15/16

(52) U.S. Cl. 709/203; 718/101

(57) ABSTRACT

A system distributed over a network for aggregating multiple disparate batches of media files for inclusion into a collection of media files includes a first computing device on the network for creating and defining a collection, a server on the network for validating the created collection and publishing the collection on the network, and one or more computing devices on the network for receiving a machine readable code notifying of and describing the collection and for contributing media files to the collection. The machine-readable code specifies the collection, the code including collection attributes and a collection identifier and wherein the machine-readable code is rendered available to the one or more computing devices that may contribute to the collection, the code is processed to establish objective criteria for identifying contributed batches of media files for automated aggregation into the collection.

### CROSS-REFERENCE TO RELATED APPLICATIONS

The present invention claims priority to a U.S. provisional patent application Ser. No. 60/823,659, entitled “A System and Method for Aggregating Multiple Independent Batches of User-generated, Digital Media into a Single, Consolidated Collection for Simplified Sharing, Distribution and/or Publishing”, filed on Aug. 27, 2006, disclosure of which is included herein at least by reference.

### BACKGROUND OF THE INVENTION

1. Field of the Invention

The present invention is in the field of digital processing, annotation, retrieval, and delivery of digital media, including digital photos, images, videos, movies, and audio data and pertains particularly to methods and a system for aggregating batches of digital media for the purpose of publishing a collection for sharing.

2. Discussion of the State of the Art

In the field of digital media consumption, consumers now have the ability to create digital media using a wide range of imaging or other digital recording devices. Examples of digital media include digital photos, digital images, digital video, and audio data. Typical imaging devices used today might include handheld camera-enabled devices, such as a digital camera, digital camcorder, and mobile phone. Other devices include web cameras, digital sound recorders, and document/image scanners.

There are many companies that offer digital media sharing sites and services, including software to enable consumers to store, organize, edit, publish, and share digital media with other users, most commonly over a network such as the Internet network. Examples include Google™ Picasa2™, Apple iPhoto™, Microsoft PictureIt™, Adobe Photoshop™. Available media sharing sites include Shutterfly.com, Kodakgallery.com, Snapfish.com, Flickr.com, Photobucket.com, Tabblo.com, OneTrueMedia.com, Riya.com, among others.

A common problem with such sites is that as the volume of digital media produced by consumers, both individually and collectively, grows, it becomes increasingly difficult to organize, manage, and share that media. Particularly challenging is the ability to quickly and easily identify, share, and retrieve all the digital media created by all the individuals participating in a particular media sharing session or event. Another challenge is the ability to quickly and easily identify, share, and retrieve all the digital media created by one or more individuals where the media files share a common attribute, such as topic, theme, location, and so on.

In current art, manual tagging is practiced whereby metadata is tagged to individual media files and to collections of media files, the metadata including one or more keywords or other textual attributes. In some cases, digital files are automatically examined and processed for specific qualities, characteristics, or attributes that might be intrinsic to the image or attributes that accompany the image as external attributes.

In the first example, this can be accomplished either 1) directly by embedding the meta-data directly into the digital media file (e.g. JPG/EXIF file format), or 2) indirectly through a database application. Where the meta-data relates to event, theme, or content-based attributes of the media file, this approach commonly requires the efforts of a knowledgeable person to manually review each digital media file before determining and assigning semantically appropriate keywords and/or attributes. This is a very tedious process prone to errors of omission, subjectivity, and inconsistency; and in practice, only a very small fraction of digital media files ever have event, theme, or content-based attributes attached.

In the second example, automated digital media processing techniques are available such as voice recognition, color mapping, pattern recognition, facial recognition, optical character recognition (OCR), and so on. Automated image processing techniques are typically limited in their ability to extract higher-level event, theme, or content-based attributes from the image data.

What is clearly needed is a system and methods for automated creation of collections of digital media from multiple independent batches of contributed media files

### SUMMARY OF THE INVENTION

The inventor provides a system distributed over a network for aggregating multiple disparate batches of media files for inclusion into a collection of media files. The system includes a first computing device on the network for creating and defining a collection, a server on the network for validating the created collection and publishing the collection on the network, and one or more computing devices on the network for receiving a machine readable code notifying of and describing the collection and for contributing media files to the collection. The machine-readable code specifies the collection, the code including collection attributes and a collection identifier and wherein the machine-readable code is rendered available to the one or more computing devices that may contribute to the collection, the code is processed to establish objective criteria for identifying contributed batches of media files for automated aggregation into the collection.

In one embodiment, the network is the Internet network. In one embodiment, the first computer is one of a desktop computer, laptop computer, personal digital assistant, or a mobile cellular telephone. In this embodiment, the one or more computing devices are one of or a mix of desktop computers, laptop computers, personal digital assistant, network-enabled digital imaging devices, or mobile cellular telephones.

In one embodiment, the collection of media files contain individual ones of or a mix of digital images, digital videos, or digital audio clips. In one embodiment, the machine-readable code is one of a bar code, a digital image or a universal resource locator containing a command string. In one embodiment, the server includes a machine-readable code decoder and a media tagging utility for decoding a machine-readable code accompanying a batch of media files and tagging the media files with collection attributes.

In one embodiment, the collection attributes include one or more theme-based attributes, event-based attributes, location-based attributes, time-based attributes, and descriptive keywords. In one embodiment, folksonomy is used to attach keywords to media files of a collection. In one embodiment, a contributed batch of media files is identified by a media batch identifier tagged to each media file belonging to the batch.

In one embodiment, a collection identifier and one or more batch identifiers identify a collection of media files, the media files searchable by identifier and any other attribute tagged to one or more of the files. In one embodiment, the media files belonging to a collection are stored and retrieved from multiple network-connected storage locations.

According to another aspect of the invention, a method for identifying and aggregating one or more contributed media files into a single collection of contributed media files for public consumption is provided. The method includes the steps (a) specifying the collection with collection attributes and generating a machine readable code containing the attributes, the code rendered available to contributors, (b) decoding the machine-readable code, using the decoded attributes to locate the media files to be sent for aggregation into the collection as a batch, and (c) Sending the contribution files or locators to those files with the MRC to a publishing entity.

In one aspect of the method, the machine-readable code is created by the original author of the collection and validated by the aggregator using a collection identifier before batches of media files are sent. In one aspect, in step (a), the machine-readable code is captured as an image by one or more contributors of the one or more batches of media files. In one aspect, the machine-readable code is one of a bar code or a universal resource locator containing the machine-readable code as a command string.

In one aspect of the method, the collection attributes contain one or a combination of theme-based data, location-based data, event-based data, time-based data, and collection identification data. In a variation of this aspect, the location-based data is global positioning satellite data or the equivalent.

In one aspect of the method in step (a), the machine readable code contains event title, event date, event time information, collection network location and collection identifier. In one aspect the machine readable code further includes a global positioning satellite coordinate or a range of such coordinates.

According to still another aspect of the present invention, a removable media is provides, the removable media containing thereon a set of machine-readable instructions causing a device to perform steps (a) decoding a machine-readable code rendered available to the device; (b) forming a query from decoded information, the information identifying a media collection of an event including date, time, and/or location of the event; (c) searching for media files available to the device that were captured during the date and time and/or location specified in the query; and (d) gathering those matching files into a batch of media files for contribution to the collection of media files.

In one embodiment, the device is one of a computer, a digital camera, a personal digital assistant, or a smart phone. In one embodiment, in step (a), the machine-readable code is a bar code captured as a photograph by the device or obtained as an image by the device. In another embodiment in step (a), the machine-readable code is a network navigation string containing the encoded information.

In one embodiment, the removable media includes a further instruction causing the device to perform a further step of navigating to a server and obtaining an identifier to identify the contributor of the media files.

### BRIEF DESCRIPTION OF THE DRAWING FIGURES

FIG. 1 is an architectural overview of a media-sharing network supporting practice of the present invention.

FIG. 2 is a block diagram illustrating components of a contributor application according to an embodiment of the present invention.

FIG. 3 is a block diagram illustrating components of an organizer application according to an embodiment of the present invention.

FIG. 4 is a process organization chart illustrating interaction between participating entities practicing the present invention.

FIG. 5 is a block diagram illustrating components of a controller application according to an embodiment of the present invention.

### DETAILED DESCRIPTION

The inventor provides a system and methods for aggregating disparate batches of media files from various contributing sources (individuals) that have attended an event and have captured or recorded media at that event and organizing those batches of media files as a collection, which may be browsed and accessed over a network and which may be updated by new contributions. The invention will be described in various embodiments made clear in the following detailed description.

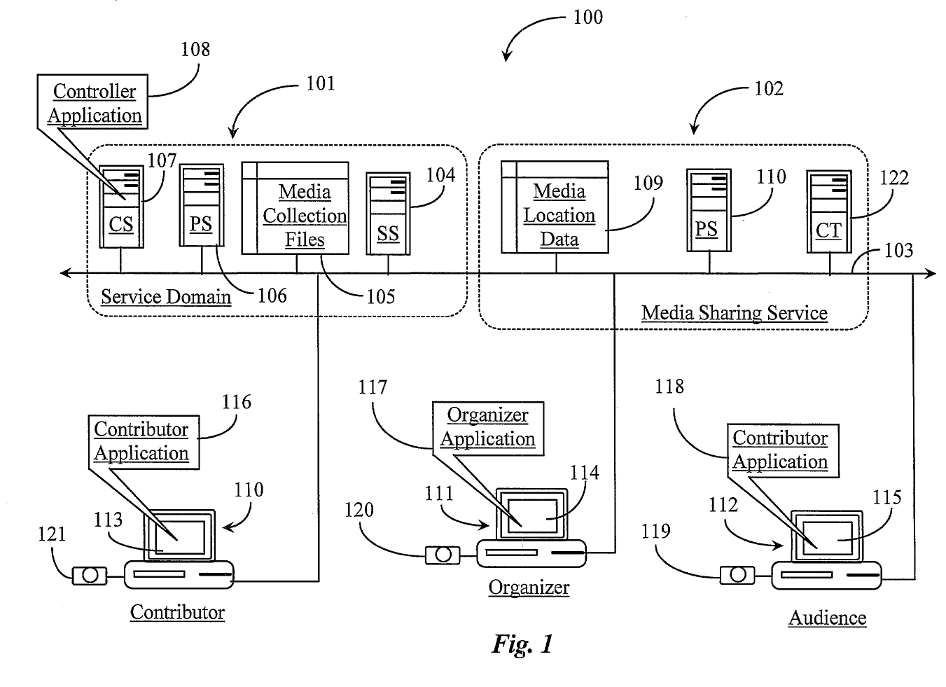

FIG. 1 is an architectural overview of a media-sharing network 100 supporting practice of the present invention. Media sharing network 100 is exemplified by a network backbone 103. Network 100 may be the Internet network, a corporate wide-area-network (WAN), a municipal-area-network (MAN), or another type of digital network. In this example network 100 is the Internet network and will be referred to hereinafter as Internet 100. Backbone 103 represents the Internet backbone including all of the lines, equipment, and access points that make up the Internet as a whole including connected, wired and wireless, sub-networks that support Internet protocols like transfer control protocol/Internet protocol (TCP/IP).

A service domain 101 is provided for the purpose of hosting the capabilities of the present invention in this example. Service domain 101 may be hosted by a business providing one or more services related to the invention. Service domain 101 includes a public server (PS) 106 connected to backbone 103. PS 106 may be adapted as a public access server for customers who wish to register for and receive services relevant to the present invention including software to enable practice of the present invention.

It is not absolutely required that the present invention be practiced over the Internet or any other WAN. In one embodiment the invention may be practiced locally over a wireless ad-hock network or locally on a local-area-network (LAN) depending on the particular embodiment. In this example the Internet is used and a company hosting service domain 101 provides the invention and participates in the practice of the invention.

Service domain 101 includes a controller server (CS) 107 having an instance of controller application 108 provided thereto and executable locally or remotely. CS 107, aided by software (SW) 108 is adapted as a centralized control and management server that aggregates and or accepts batches of media files into a collection for publishing and sharing. CS 107 provides unique global identifications for collections assembled and for individual groups or batches of media files that eventually become part of a collection of media files. A collection of media files may be a collection of digital images, a collection of digital movies or movie clips, or a collection of audio clips or songs. A collection may also include a mix of digital media types.

Service domain 101 includes a search server 104 adapted to enable crawling or searching through media files to identify files that are to be processed and added to a collection. In one embodiment, media files to be added to a collection are uploaded to service domain 101 and are stored in a media data repository 105 included within domain 105 and adapted for the purpose. Generally speaking, media files added to a collection of media are contributed to the collection in batches of one or more files.

A contributor to a media collection may be any individual registered to a service of the invention that has a computing device capable of capturing or uploading captured media and that has network access in this example. A contributor station 110 is illustrated in this example and represents a contributor of digital media. Contributor station 110 is connected to Internet 100 via any one of a number of known connection methods. Station 110 may receive Internet access through digital subscriber line (DSL), cable/modem, wireless broadband, dial-up connection, or the like. In this case the contributor station is a desktop computer. In other embodiments, other types of computing devices may be used to practice the invention such as a laptop computer, a personal digital assistant (PDA), a smart-mobile telephony device, a network-enabled digital camera or camcorder, or some other hand-held computing device capable of network access.

Contributor station 110 has a contributor application 116 provided thereto and executable there from. Contributor application 116 may take the form of a browser-based application that may be integrated with a traditional network browser illustrated herein as a browser 113. Contributor application 116 may be packaged and sold installable from a CD-ROM for example, or it may be downloaded from service domain 101 such as from server 106.

Contributor station 110 has a media capture device 121 connected thereto. Media capture device may be a digital camera connected to station 110 via a universal serial bus (USB) or it may be a networked imaging device such as a camera-enabled mobile phone or a WiFi-enabled digital camera that can directly or indirectly upload images to a storage location that is accessible to the contributor station. In one embodiment, an individual operating from station 110 may capture images with camera 121 and upload a sub-set or all of the captured images to station 110 some images of which may be earmarked for a contribution to an identified collection. Device 121 may be a video recorder or an audio recorder instead of a still image camera. Most single digital media capture devices are adapted to capture all media types.

A media collection is originally identified as a current collection of media by a media collection organizer. A media collection organizer may be any individual registered to a service of the invention. A media collection organizer is one who originally registers and introduces a defined media collection to which the organizer and or other individuals may contribute additional media too as a contributor. A collection is created and registered with the service, in one embodiment, ahead of a planned event at which individuals may attend, capture media at the event and eventually contribute that media to the collection. Therefore, a collection is typically set-up in advance of the planned event, however that is not absolutely required in order to practice the present invention.

An organizer station 111 is illustrated in this example and is connected to Internet 100. Organizer station 111 is a desktop computer with a media capture device 119 connected via USB. However like station 110 described above, station 111 may be any type of computing device capable of accessing the network. In this example, station 111 also has a digital camera 120 connected thereto via USB.

Organizer station 111 has an organizer application 117 provided thereto and executable there from. Organizer application 117 is adapted as software to enable a user to define and register a collection that will eventually include contributed media files with the service of the invention. The process may be similar to registering and creating a chat or Net Meeting™ ahead of participation. Organizer application 117 may take the form of a browser-based application that may be integrated with a traditional network browser illustrated herein as a browser 114. Organizer application 117 may be packaged and sold installable from a CD-ROM for example, or it may be downloaded from service domain 101 such as from server 106. An individual may use application 117 in one embodiment, define and register an original media collection including the descriptive attributes that might define a collection of media files. For example, descriptive attributes may be theme-based, content-based, event-based, time-based, location-based or a combination of those.

Both organizer application 117 and contributor application 116 may be adapted to communicate directly with controller application over a network connection. In an embodiment where only a local ad-hoc network is used, then applications 117 and 116 may be adapted to communicate directly to one another. In this case, the controller application may be integrated into either or both of the other applications running on individual computing stations. In this example, a centralization of control is illustrated with respect to domain 101 and controller server 108. It is noted herein that a same individual may be both a contributor of media files to a collection and a collection organizer. Therefore, contributor application 116 and organizer application 117 may be combined as a single application executable on one computing device.

One with skill in the art of media collecting will appreciate that many media collections created and managed on a network are there for an audience to consume. In most of these types of applications there is a network media share service hosted by a company. Media sharing services come in many different forms. Popular services include music sites that enable sharing and consumption of music, video sites that organize and present video shorts and macromedia clips, photo sites that maintain user photos online, and general file sharing services that promote sharing of any media types between registered users.

A third-party media sharing service 102 is illustrated in this example. Service 102 may be any type of service that enables registered or un-registered users to access media and share files with one another over the network. Some of these services have some type of peer-to-peer network connection model, others may have a more traditional client-server network model. For example, some music services enable user's to create a share folder where they may deposit contributed media. When the contributing user is online, users searching for a song may be presented with a search entry that includes the universal resource locator (URL) to the media on the user's device.

Media sharing service 102 has a public access server (PS) 110 adapted to enable users to register and use the services. In one embodiment of the present invention, the entity hosting service domain 101 forms a strategic alliance or partnership with the entity hosting media sharing service 102 for the purpose of gaining syndication of media files from an established media sharing company.

In the case of partnering, media sharing site 102 requires the technical capability to discover and decode machine readable code (MRC) from within batches of contributed media, and having processed MRC or received the equivalent data from an external source, to quickly identify and select media files within batches that may belong to a respective collection on an ongoing basis. The capability is required according to an embodiment of the invention to automatically identify media files from appropriate contributor batches and media batches that might be contributed to appropriate media collections originally registered by organizers. The actual connection scheme for sharing media among users may be peer-to-peer or by centralized media broker (proxy). In one embodiment of the present invention, service domain 101 performs all of the required tasks for discovery, any syndication issues, and distribution.

An audience station 112 is illustrated in this example and represents any consumer of media operating a computing appliance with access to the network. Audience station 112 is a desktop computer in this example. However, station 112 may be another type of computing device as was described further above with respect to contributor station 110 and organizer station 111. It is noted herein that audience station 112 is running an instance of contributor application 118 as a plug-in to browser 115, however this is not required for the practice of this invention. A single individual may be a contributor, an organizer, and part of the consuming audience all from the same appliance. Similarly to the above-described stations, audience station 112 has a media capture device 119 connected to it via USB.

SW applications 116 and 117 may be combined as a single SW application on one computing system. Likewise, all of the software including contributor application 116, organizer application 117, and controller application 108 may be installed on a central network server that is accessible to consumers. In this case, all of the applications may run on PS 106 or perhaps PS 110. Network share site has a data repository 109 adapted to store attribute data and location information for media collection files stored on one or more media access servers (not illustrated). In one embodiment, actual media files may be stored on servers, computers, or other appliances connected to Internet 100 and the network locations and attribute data of those files, which are part of a registered collection is managed centrally in repository 109. In another embodiment, the network locations of the files including the data attributes of those files are stored repository 105.

In practice of the present invention, an organizer registers a media collection that will eventually be populated with media captured at the event described by the media collection. The media collection is defined using descriptive attributes. The organizer with the aid of SW 117 applies or generates a global ID that is unique to the registered media collection. The identification may be incorporated into machine-readable code (MRC). SW 117 may work in conjunction with SW 108 to register and apply the identification to the media collection. The organizer with the aid of SW 117 may also process each and any of the media files in the media collection which may already exist by adding relevant attributes of the collection into each file so that those files and attributes may later be easily discovered by a browsing audience.

The files may be uploaded to repository 105 for storage and maintenance and controller server 107 aided by SW 108 may discover the collection and publish or cause publication or syndication of the collection for consumption over the network. Once a collection is ready for consumption, service domain 101 or if partnering, network share site 102 may render the files or file locations available to network browsers and may also continue to distribute a machine-readable code, which may be rendered as an image or a printable file, to potential contributors such as contributor station 110 if contributions are still being accepted by the collection organizer. That is to say that a collection may or may not be assigned a time window within which contributions may be accepted.

If station 110 wishes to contribute to a media collection originated by organizer 111, the MRC image or other code is captured or otherwise acquired by the contributor and decoded. The attributes extracted or parsed from the MRC are then used to search, identify, and locate media files that are accessible to the contributor station or device that might belong to that media collection (e.g. those media files inferred to be captured during the event) and that might be contributed. The contributor may submit a request to SW 108, which might include the global ID of the collection (from the MRC) and receive a unique media batch id to be assigned to the media files to contributed to the media collection. Again, the contributed media files may also be processed locally to annotate or tag the contributed media files with attributes derived from the media collection and/or the MRC and simplify the subsequent management of said media files.

During the time to live (TTL) of contributions accepted to a collection, there may be several contributions to the media collection that must be discovered and managed, at least by file location. As each contribution occurs and the files are aggregated into the media collection, new notifications may be sent to consumers or posted for consumers that the media collection includes a new update. Consumers may then browse an entire media collection, or retrieve only files that were contributed by a specific contributor, under a specific batch ID, or by some other attribute included in the definition process. The method of the present invention enables the contributed files to be aggregated into a media collection automatically by executing a query containing some combination of the defined media collection attributes and ID's against a pool of media files to quickly identify the set of files that should be contributed to the media collection and re-published as part of the updated collection.

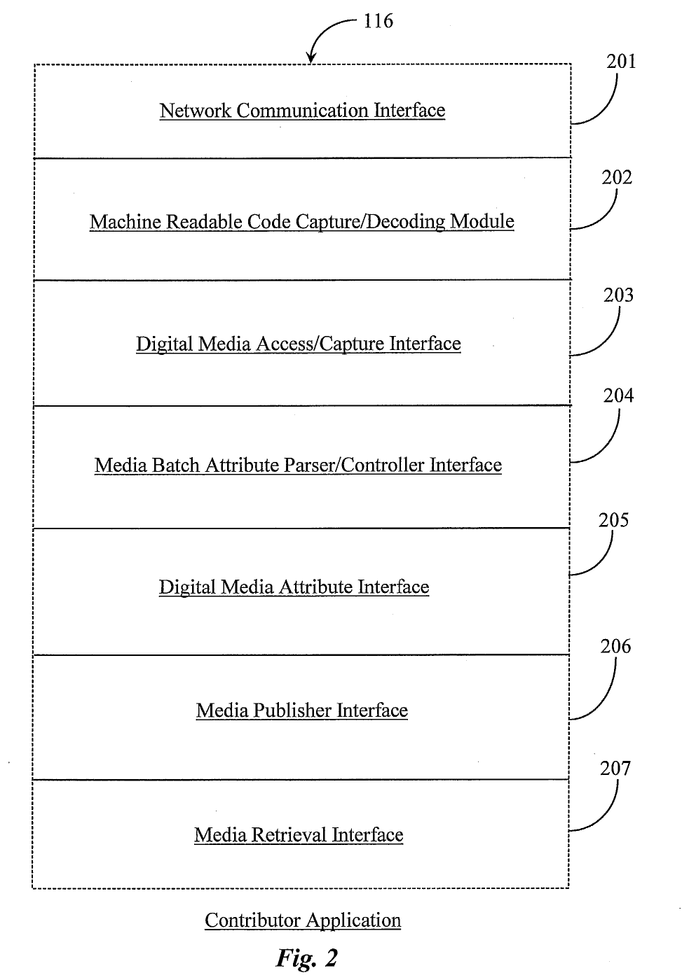

FIG. 2 is a block diagram illustrating components of contributor application 116 of FIG. 1 according to an embodiment of the present invention. Contributor application 116 may be provided as an installable application from CD-ROM or other removable media or it may be downloaded from the Internet as an application or as a browser plug-in. As a browser-based application, application 116 includes a network communications interface 201, which may rely on browser-based functionality. In one embodiment layer 201 opens a channel to controller application 108 described further above.

Application 116 includes a machine-readable code capture and decoding module 202. A machine-readable code (MRC) is an expression of and vehicle for attribute and/or command data represented as an object, such as an image, which can be easily captured or retrieved by a digital device and then, automatically or by user action, processed/read by software such that it is accurately converted into back into its original data elements. A typical example in the visual domain is a 1 or 2 dimensional bar code or character text output that is easily decoded by optical-character recognition (OCR) software. Another type of MRC example would be a click-able object in a software application that when clicked will also produce comparable attribute and/or command data for subsequent processing. Application 116 may capture an MRC (image) and then may scan, decompress, or otherwise decode the image for the embedded information contained in the image. The encoded attributes of a media collection are used to help the contributor determine if (1) they will contribute to the media collection and (2) what media files accessible to Application 116 are appropriate for contribution to the media collection. In one embodiment, contributor application 116 may also include an MRC generator module that may be integrated with module 202, for example.

Application 116 includes a digital media capture interface 203 adapted for the purpose of acquiring digital images from local storage. In one embodiment, interface 203 includes a scanner interface to an optical scanner and a selection for acquiring an image. In one embodiment, the device hosting application 116 is capable of video and/or still image recording in which case capture interface 302 may include a capture command for media that is currently being recorded by the host device.

Application 116 has a media batch attribute parser/controller interface 204. Once a contributor discovers/receives and decodes an MRC containing attributes and identification of a published collection to which files may be contributed to, the contributor may parse and read the attributes of the collection. Theme-based, location-based, event-based, and content-based attributes may be present that describe in some detail the nature of the published collection. In one embodiment, the contributor may access any additional attributes from the controller application in a networked environment. In this case, the user may query the controller using the collection ID as a locator or database key. In this way any additional information not originally included in the MRC can be retrieved over the network. In one embodiment the MRC may minimally include the collection ID, a URL locating the collection server and collection object, and a title, location, date, and time of the event for which the collection object was created.

Application 116 includes a digital media attribute interface 205 adapted to enable the contributor to apply attributes to a batch of media files designated for contribution to a published collection of media files. Such attributes like descriptive keywords for example may be collected and associated to the media files that were contributed. Interface 205 may also include a utility for tagging individual media files with keywords and other text information for audience dissemination. In one embodiment, interface 205 is used to associate media collection attribute data to each individual media file to be included into to a collection. The contributor may upload both processed and unprocessed media files or media file locators to a central computer or server that is running the controller application. The controller application may then be used to discover the appropriate files of the contributed batch that should belong to a particular collection. In this event, the controller server may individually process all of the media files or media file locators to be added from a batch by tagging each one of them with collection attributes, keywords, batch ID and collection ID. In this way, an audience may easily retrieve the files. The forgoing functions may all be accomplished in automated fashion.

In one embodiment of the present invention, application 116 includes an optional media-publishing interface. Media publisher interface 206 may be executed to forge a data communication channel between the contributor and a media-publishing and sharing site. In one aspect, the contributor deals with a third-party media-sharing site to pass off the tasks of preparing the media for addition to a public media collection. In this case, the media site may be enhanced by the software of the invention to discover, decode and process MRC included in a batch of media files, retrieve the attribute and command data of the related media collection, and subsequently search, identify and locate media files from within the same batch of media files which are to be contributed to the media collection referenced by the MRC. It is not particularly important where those files may be located on the network as long as they are stored in a location that is accessible to a host charged with discovering those media files.

In one embodiment of the present invention, application 116 includes a media retrieval interface 207 adapted for enabling the user to download media files from a collection of media files that is available on the network. Interface 207 may be adapted to forge a connection with a third-party media-sharing site.

Interfaces 207, 206, and 204 may all leverage network communication interface 201 for network functionality. Application 116 may be provided with fewer or more individual components or modules than are illustrated herein without departing from the spirit and scope of the present invention. Likewise, depending on the application, media interfaces to third-party sites may not be provided.

In one embodiment, application 116 includes a tagging utility that can embed data attributes belonging to a media collection directly into each media file designated for contribution to that media collection, which may further include a media batch ID and additional attributes related to the batch of media files. In another embodiment, this process may be performed on a centralized computer such as one hosting the controller application. In either case, a contributor may simply upload a batch of properly tagged media files irrespective of any MRC and the central computer will properly identify and contribute those files to a media collection by locating the media collection and batch attribute data within those files. There are many variations of the process, at least one of which will be described in detail later in this specification.

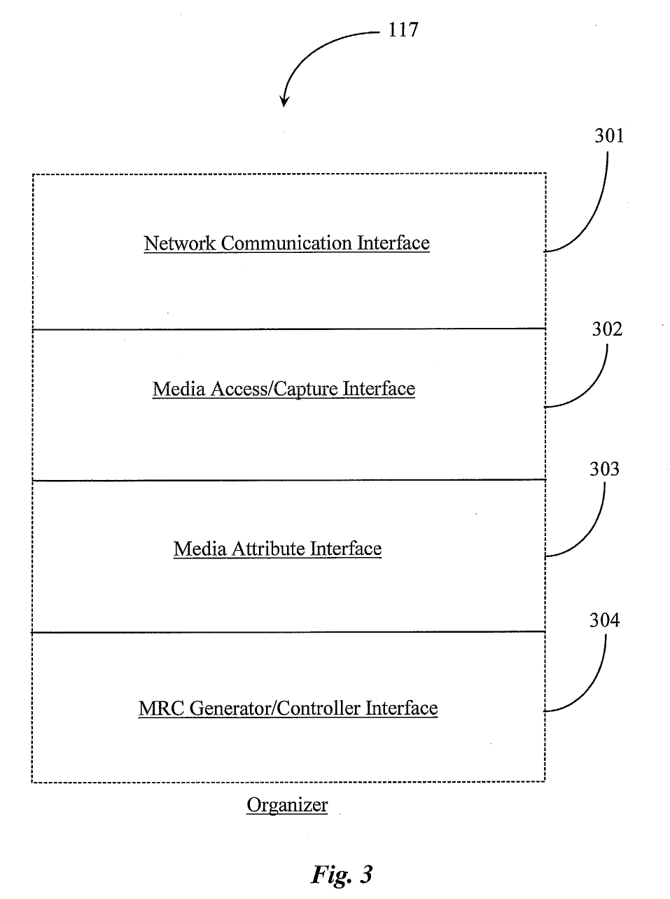

FIG. 3 is a block diagram illustrating components of organizer application 117 according to an embodiment of the present invention. Organizer application 117 is adapted to enable an individual working from a network-connected station to create and register a collection that describes a past or planned event. Application 117 includes a network communication interface 301 adapted to enable communication on the network. In a browser-based embodiment this interface may simply be the browser network interface functionality.

Application 117 includes a media access/capture interface 302. Interface 302 is adapted to enable the organizer to access locally stored media for inclusion into an original media collection created for publishing. A media collection may be created that is initially empty if the organizer is not immediately contributing media to the collection. On a device having media capture capabilities, interface 302 also enables inclusion of media files that are instantly acquired or captured by the device itself or a connected peripheral device. In other words a collection may be created during an event at which time contribution may be forthcoming during the span of the event.

Organizer application 117 includes a media attribute interface 303. Interface 303 is adapted to enable an organizer to create all of the attributes of the collection such as title, date created, event duration, event keywords, location information or any other pertinent information. In one optional embodiment, interface 303 may include a tagging capability for embedding data into the individual image files that the organizer may contribute. However this is not required in order to practice the invention. For the purpose of clarity, an event may be one that spans anywhere from a small amount of time, perhaps hours, to one that spans over several days or weeks. For example, a wedding or baby shower may last only a few hours whereas a bicycle race may last a week or more.

Organizer application 117 includes a MRC generator/controller interface 304. Interface 304 enables the organizer to generate an MRC image that may include all of the collection attributes created including a global unique identifier (GUID) and collection location information (URL) that is used to flag or identify and to register a collection and to navigate to that collection. Generating a random code and appending that code with the originating device serial number, for example, may generate this identifier locally in one embodiment. In one embodiment, application 117 interfaces with a controller application using interface 304 and interface 301 to obtain a generated GUID during the registration process for registering the collection. The MRC generator may produce a MRC image that may be retrieved and uploaded with the actual media files of the collection. The MRC, if an image, may also be captured locally by the organizer or other contributors or persons attending the event.

To exemplify, if the event is a wedding, the collection may be pre-registered by the organizer and the MRC may be printed as a bar code, for example, on the wedding guest list. Potential contributors might snap a photo of the code off of the guest list and software (contributor application) on their devices or host stations later decodes the MRC and gathers the images that they took during the event for contribution. It is important to note herein that in one embodiment, contributors do not have to have any special software to practice the invention. In this case, the contributors may go on-line to have their MRC decoded and their images gathered for contribution.

In the above embodiment, potential contribution files are “discovered” at a central network destination by locating the MRC from within a batch of media files uploaded during a session and extracting the collection ID along with any other attribute data from the MRC. This data may be used in a search query to locate and identify the actual media files from the batch that might belong to the media collection. Alternatively, the search query may go beyond the uploaded batch to encompass a broader set of media files on the contributor's device, station, or third-party media storage account. In another embodiment, uploaded media files previously identified as belonging a registered media collection may be properly contributed by writing the appropriate media collection attribute tags directly into data headers of each media file. If the media collection is partially described by location-based attributes, global positioning satellite (GPS) coordinates embedded in the media file might be used as one of the criteria to identify media files on a contributor's device or station that may belong to a collection. In another embodiment, the files may be uploaded into a segregated queue including the MRC image and then stored in a repository in a segregated fashion with attributes decoded from the MRC assigned as the database locator or key.

In still another embodiment, the actual image files comprising a collection may be stored locally on different storage devices maintained by contributors wherein those files are discovered over the network by the audience using the attributes decoded from the MRC to find those files. As long as the storage devices are registered on the network and have a network address, the files may be remotely managed and do not have to be centrally stored in one repository. A combination of this scheme may also be practiced. For example, some media files belonging to a collection may be stored at third-party media sites while others of the same collection may be stored on contributor stations and still others maintained in a central database. There are many possibilities.

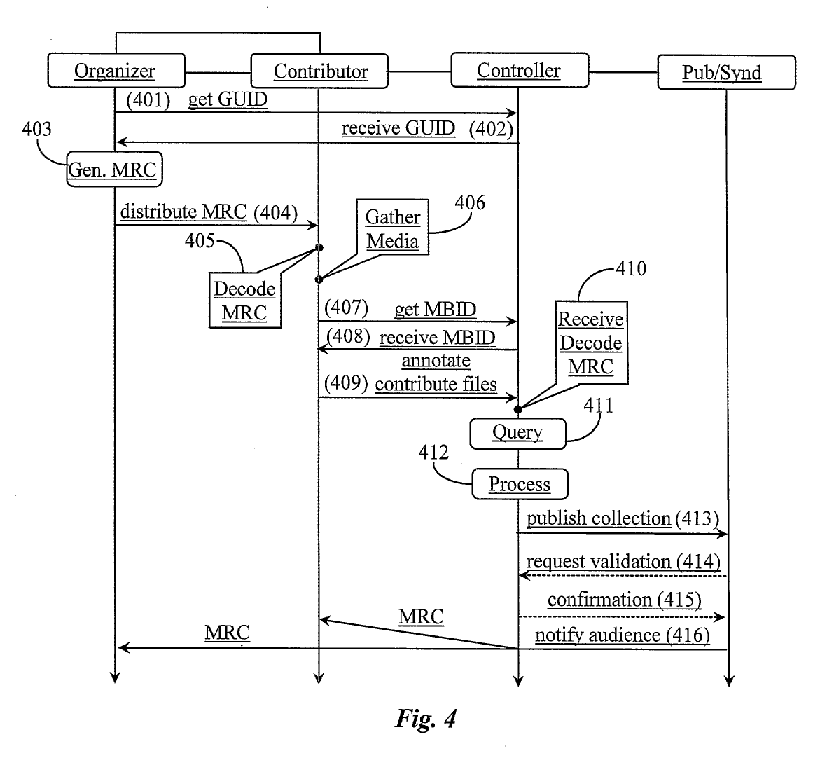

FIG. 4 is a process organization chart illustrating interaction between participating entities practicing the present invention. There are 4 main entities that may be involved in facilitating media collection management and making dissemination of media collections practical. These are an organizer, a contributor, a controller, and a publisher/syndicator. It is noted herein that the controller and publisher/syndicator functions may be performed by a same entity. In this example, the entities are separate and the publisher/syndicator entity may be a third party media sharing site or service.

The organizer is an individual operating from a remote station or device connected to the network that originally creates a collection and registers the collection for eventual media contributions and collection publication over the network. The contributor is an individual operating from a remote station or device that receives or has received notification of an event, possibly including on- or off-line access to MRC describing a media collection dedicated to the event and who makes a decision to contribute media files captured at the event to the registered collection. A controller is an automated system that facilitates the origination and registration of a media collection and facilitates contributions to registered collections. The publisher/syndicator is a third party entity like a media sharing site or first-party entity like the controller host that provides access to the registered collection over the network and provides updated information about those collections to consumers. In this example, a third party is partnering with the host.

A process is provided and is illustrated in this chart that describes the interactions between the entities described above relative to origination of a collection, contribution to the collection and notification of the published collection to consumers. This embodiment assumes an online embodiment with centralized collection management. At step 401, an organizer decides to create a media collection for an event and forges a connection to a controller in order to request a globally unique identifier (GUID) for identifying the collection. At step 402, a GUID is generated at the controller and is sent to the organizer for use. In most instances the organizer has an event planned and creates the collection well ahead of the date and time the event will take place. It is also noted herein that it is possible that more than one collection may exist for a same event.

At step 403, the organizer with the aid of the organizer software generates a MRC that includes at least, the collection GUID, but also an event title, an event start date/time and end date/time. The MRC may include GPS coordinates of the event or other event location data. In one case the MRC may include all of the attributes that the organizer has applied to the collection definition such as theme-based, event-based, and content-based data in addition to the GUID that uniquely identifies the collection. Still further, the MRC may include a defined time window within which contributions to the collection will be accepted.

At step 404, the organizer may then distribute or otherwise render the generated MRC available to one or more potential contributors. The MRC may be an image that may be captured by a digital imaging device and that may be decoded on the same device. Therefore, at a localized event the organizer may simply pass out printed versions of the MRC, which may be captured on the digital cameras of any individuals that made an appearance at the event. It is noted that there are many ways to render the MRC available to event goers such as before the event by email or some other digital messaging system. In one embodiment, the MRC may be sent out with event invitations or provided on the face of placemats or menus at the event. There are many variant possibilities.

At step 405, a contributor decodes the MRC. This is one who intends to contribute media and has captured or will capture media during the event. It is noted that the contributor may capture media including an image of the MRC using the same capture device. The contributor may decode the MRC during the event, toward the end of the event, or well after the event has terminated as long as the collection is still accepting media contributions.

At step 406, the contributor may use the decoded attributes from the MRC, specifically date/time information, in a query to gather media files that belong to the media collection and that might be contributed to the collection. The query may be transparent to the contributor such as incorporated into a menu on the user's station or device display. For example, a menu button on a smart telephone device may give the option of depressing a mode button to aggregate files from memory like a secure digital (SD) card according to MRC information that has been also decoded on the device or station. The physical aspect of aggregation may vary from device to device or from device to station. For example, aggregation may simply be tagging the candidate media files associating them to media collection attributes decoded from the MRC and presenting a navigable list to those tagged media files for review. In another embodiment, aggregating the files may include physically copying those files into a segregated folder where they may be viewed, sorted or otherwise validated manually.

During the event or at some later time after the event, the contributor may contribute media files to the collection. At step 407, the contributor may execute the MRC in one embodiment to go online and navigate to the collection host or controller in this example to get a media batch identifier (MBID). At step 408 the controller responds by generating and sending a unique MBID back to the contributor. The MBID identifies the contributor and the media files contributed by that contributor as distinct from other contributors and media files also in the media collection. The controller may register the MBID with the media collection.

At step 409, the contributor may annotate and contribute files. The files may be annotated with the MBID and any other captions, keywords, and/or media collection attributes that might be used by audience members to retrieve those contributed files enabling the audience to associate those files with the person that contributed them. In step 409, the contributor may actually upload a batch of files along with the MRC. In another embodiment, the user may simply upload the network location of those files and file attributes with the MRC. In another embodiment, the user may simply upload files or network file locations of files annotated or tagged with the appropriate media collection attributes, and not upload the MRC.

At the controller in step 410, the MRC identifying the media collection is discovered/received and decoded to extract the pertinent media collection attributes for identifying files within the uploaded batch that might be contributed to the collection. Any media files already annotated with media collection attributes are also discovered and automatically contributed to the media collection. At step 411, the controller may execute a query to select the media files from the batch of uploaded files, which might be contributed to the media collection. In one case, the user has already annotated all of the contributed media files with the proper media collection attributes, including GUID, and the controller automatically adds these files to the media collection.

In one embodiment, the contributor allows the controller to access his or her storage device to aggregate the files according to attributes related to the media collection as referenced by the decoded MRC, specifically data and time and/or location attributes. In that case, steps 406 and 407 may not be performed on the contributor station or device. In any event, at step 412, the files may be processed, if not previously processed by the contributor or processed further to include additional attributes. The process may include formally tagging each media file with collection attributes including keywords that might be used later in browsing the collection.

Steps 406 through steps 412 may be repeated for each contributor during the “window of contribution”. Publishing may occur after all of the contributions have been made or during the contribution window. In this embodiment, publishing is performed by a third-party entity. At step 413, the controller publishes the collection to the third-party site. This step may or may not involve sending actual media files. Network location data may be sent to enable the public to navigate to the station or device hosting the actual files.

At step 414 the publisher may request validation from the controller that the collection and contributions in the collection are valid or authorized, possibly by submitting of the collection GUID and even MBIDs. In this case, the controller may send confirmation back to the publisher at step 415. At step 416, the publisher may notify an audience, which may be the general public or a selected membership of the published collection by sending or posting notification, possibly including the MRC.

The MRC may also be an executable link to the collection. One who uses the MRC to navigate the collection may decode the MRC for attributes that might be used to browse specific portions of the collection. For an example, a wedding may include separate sub-events such as the cutting of the cake, the father-bride first dance, and so on. The collection attributes may include separate keywords to those sub-events. Likewise, such keywords and categorical links may be retrieved from the collection host or the controller using the MRC to navigate to the controller. In this embodiment, the MRC both enables automated aggregation of media files for contribution to a collection and semi-automated navigation of specific categorical sub-events of the collection.

In one embodiment, an audience may use folksonomy to tag certain contributed media files or batches of files for easy repeat reference. In this case, general users may add attributes to the collection or to media files in the collection, those attributes added to the collection data and used by others to search the collection. It is noted herein that there are many possible process order and task variations that may be observed depending on the application. In this case, the publisher syndicates the collection, posts the description, and sends the MRC to a potential audience.

It is noted herein that there are many supported protocols and methods for conveying information about a media collection between entities including. Electronic mail and messaging programs, the browser interface, and a file transfer protocol (FTP) server, among other methods. The applications may also communicate with each other using really simple syndication (RSS), hypertext transfer protocol (HTTP) extensible markup language (XML), simple object access protocol (SOAP), and others.

The media collection, including its descriptive attributes and contributed media files, may be continually updated without ever altering the MRC. The controller or the publisher maintains any additional data attributes describing the history and chronology of the contributions to the collection. In this example, the publisher and syndication modules are combined at a third party site, which may be a media-sharing site. In another embodiment there may be no third-party involvement. Rather, the publishing and syndication is performed by the entity hosting the controller application.

The present invention focuses, in one embodiment, on aggregating files for contributing to an event-based media collection wherein those files are automatically associated to a media collection based on the fact that the media files were related to MRC describing the media collection (e.g. the media files were captured on the same device and in the same batch as the MRC), and thus presumed to be captured at the event described minimally by date and time. In some embodiments, GPS coordinates are routinely embedded into the headers of the individual media files so in addition to other attributes, the contributor SW may aggregate files based on GPS data which matches the location-based attributes of the collection, along with the date and time data. Therefore, if you took photos at this particular location on this particular date and time, then you were presumed to be at the same event and the photos you took are most probably of the event and could possibly be contributed to the collection.

The aspect of event-based collections should not be construed as a limitation of the present invention. For example, a bird watcher that routinely visits a specific refuge to capture images of birds may initiate a collection. The organizer may create a media collection and subsequently generate an MRC, which is available at the front desk of the ranger station at the refuge. Persons visiting the refuge may take a photo of the MRC and then may venture into the refuge to snap pictures of birds. In this case, associating the users photos with the MRC may be based on a GPS coordinate range including all of the coordinates that are included within the boundaries of the refuge.

In this case contributors require GPS capability on their devices. Users would be required to activate the GPS function on their capture device so that each picture taken has the GPS data embedded into the headers of the picture file data. There may be no time window assigned for accepting new batches of photos from contributors. Later, any contributors may go the service web site and request to contribute to a collection. While online and in session, the service can retrieve the MRC from the contributor's device, decode it to determine the correct collection and then may assign the contributor a MBID. The service can use the GPS data to aggregate the photos that the user took at the refuge isolating them from many others that the user may have on the same device.

Even in this embodiment, there may be more than one collection for a same location and theme. For example, different collection may be available for the refuge such as refuge in winter, refuge in spring, refuge in summer, and refuge in fall. One MRC may include 4 GUIDs to the 4 separate collections. In this case GPS and date information would be used to isolate the contributed media files.

One with skill in the art will recognize that there may be more or fewer interaction steps and more or fewer interactive participants practicing the present invention depending in part on the scope of the architecture. For example, there may or may not be a third-party site involved. A controller may or may not receive and decode MRCs. Files may be aggregated locally on a contributor's device without being connected to a network, or they may be aggregated while connected to a network by a remote computing station that is granted access to the contributor's device. The invention may not utilize a centralizing theme for controlling aggregation of files or maintaining public collections. Therefore the exact order and description of steps presented herein should be viewed as exemplary only of one possible embodiment. In other embodiments the number and order of steps may vary.

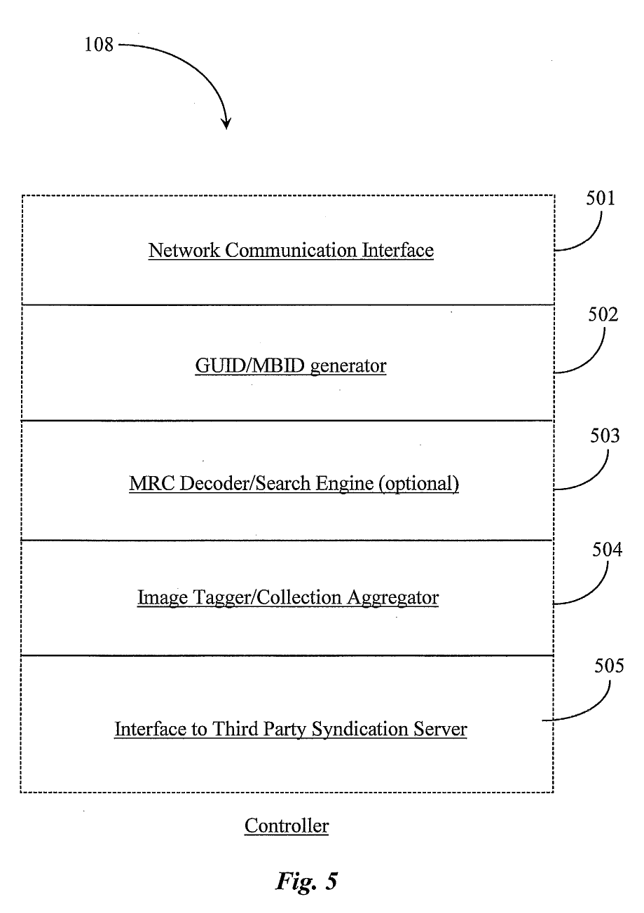

FIG. 5 is a block diagram illustrating components of controller application 108 of FIG. 1 according to an embodiment of the present invention. Controller application 108 may be hosted on a networked computing device (NCD) remote on the network from the contributor and organizer applications. Controller application 108 includes a network interface for interfacing with multiple contributor and controller applications. Interface 108 includes a GUID/MBID generator that is used to generate identifiers for collections and for media batches to be aggregated into those collections. In one embodiment, only the controller application is authorized to generate GUIDs and MBIDs and maintains a history of all of those generated and sent out over the network upon request. Contributors and organizers may send their information directly to a central publishing/media sharing site, however the site may be required to validate identifiers with the controller to verify legitimacy of a contribution or of a new collection.

In one embodiment, the controller application may include a MRC decoder and media search engine 503. In this case, the controller provides the aggregation of multiple batches of media files into appropriate collections. In one case, a batch of media files is received at the controller having an MRC included within the batch. The controller may easily decode the MRC and then form a search query based on media collection attributes decoded from the MRC to identify media files that might be contributed to the media collection.

In one embodiment, a separate process may be simultaneously executed within the controller to search out those batches containing images with MRCs and then decoding the MRCs for the attributes to locate, identify, and annotate the files and the media collections to which they may be contributed. GUID identifier can be used to retrieve all of the files of a collection. GUID/MBID can be used to retrieve a particular batch of files from a collection.

In one embodiment, controller 108 includes an image tagger/collection aggregator 504. Component 504 comes into play when the controller is doing the media file aggregating by proxy for the user and tagging those images formally for indoctrination into the collections.

Controller application 108 optionally includes a dedicated interface 505 to a third-party syndication server. In this case, the controller application has direct communication with a media-sharing site for validating received media batches. Controller application 108 may be used to facilitate aggregation of media files into the correct collections or it may be provided to the media-sharing site for use in its own system.

It is noted herein that distribution of an MRC image may not be limited to a potential contributor but may include all of those that may simply wish to locate media files within collections. For example, if a subscriber to a media share service wishes to quickly navigate to a portion of a media collection, the user could download a plug-in that decodes MRC data so that the collection attributes including the GUIDs of contributed batches of media files and URL data are human readable. The GUID can then be used as search criteria to retrieve media files or location data to those files. Similarly, any of the other attributes can be used singly or in combination to search a collection for files specific to those keywords.

It will be apparent to one with skill in the art that the media collection aggregation system of the invention may be provided using some or all of the mentioned features and components without departing from the spirit and scope of the present invention. It will also be apparent to the skilled artisan that the embodiments described above are exemplary of inventions that may have far greater scope than any of the singular descriptions. There may be many alterations made in the descriptions without departing from the spirit and scope of the present invention.

What is claimed is:

1. A system distributed over a network for aggregating multiple disparate batches of media files for inclusion into a collection of media files comprising:
a first computing device on the network for creating and defining a collection;
a server on the network for validating the created collection and publishing the collection on the network; and,
one or more computing devices on the network for receiving a machine readable code notifying of and describing the collection and for contributing media files to the collection;
characterized in that the machine-readable code specifies the collection, the code including collection attributes and a collection identifier and wherein the machine-readable code is rendered available to the one or more computing devices that may contribute to the collection, the code is processed to establish objective criteria for identifying contributed batches of media files for automated aggregation into the collection.

2. The system of claim 1, wherein the network is the Internet network.

3. The system of claim 1, wherein the first computer is one of a desktop computer, laptop computer, personal digital assistant, or a mobile cellular telephone.

4. The system of claim 1, wherein the one or more computing devices are one of or a mix of desktop computers, laptop computers, personal digital assistant, network-enabled digital imaging devices, or mobile cellular telephones.

5. The system of claim 1, wherein the collection of media files contain individual ones of or a mix of digital images, digital videos, or digital audio clips.

6. The system of claim 1, wherein the machine-readable code is one of a bar code, a digital image or a universal resource locator containing a command string.

7. The system of claim 1, wherein the server includes a machine-readable code decoder and a media tagging utility for decoding a machine-readable code accompanying a batch of media files and tagging the media files with collection attributes.

8. The system of claim 1, wherein the collection attributes include one or more theme-based attributes, event-based attributes, location-based attributes, time-based attributes, and descriptive keywords.

9. The system of claim 8, wherein folksonomy is used to attach keywords to media files of a collection.

10. The system of claim 1, wherein a contributed batch of media files is identified by a media batch identifier tagged to each media file belonging to the batch.

11. The system of claim 1, wherein a collection identifier and one or more batch identifiers identify a collection of media files, the media files searchable by identifier and any other attribute tagged to one or more of the files.

12. The system of claim 1, wherein the media files belonging to a collection are stored and retrieved from multiple network-connected storage locations.

13. A method for identifying and aggregating one or more contributed media files into a single collection of contributed media files for public consumption comprising the steps:
(a) specifying the collection with collection attributes and generating a machine readable code containing the attributes, the code rendered available to contributors;
(b) decoding the machine-readable code, using the decoded attributes to locate the media files to be sent for aggregation into the collection as a batch; and
(c) Sending the contribution files or locators to those files with the MRC to a publishing entity.

14. The method of claim 13, wherein the machine-readable code is created by the original author of the collection and validated by the aggregator using a collection identifier before batches of media files are sent.

15. The method of claim 13, wherein in step (a), the machine-readable code is captured as an image by one or more contributors of the one or more batches of media files.

16. The method of claim 13, wherein the machine-readable code is one of a bar code or a universal resource locator containing the machine-readable code as a command string.

17. The method of claim 13, wherein the collection attributes contain one or a combination of theme-based data, location-based data, event-based data, time-based data, and collection identification data.

18. The method of claim 17, wherein the location-based data is global positioning satellite data or the equivalent.

19. The method of claim 13, wherein in step (a) the machine readable code contains event title, event date, event time information, collection network location and collection identifier.

20. The method of claim 19 further including a global positioning satellite coordinate or a range of such coordinates.

21. A removable media containing thereon a set of machine-readable instructions causing a device to perform the following steps:
(a) decoding a machine-readable code rendered available to the device;
(b) forming a query from decoded information, the information identifying a media collection of an event including date, time, and/or location of the event;
(c) searching for media files available to the device that were captured during the date and time and/or location specified in the query, and
(d) gathering those matching files into a batch of media files for contribution to the collection of media files.

22. The removable media of claim 21, wherein the device is one of a computer, a digital camera, a personal digital assistant, or a smart phone.

23. The removable media of claim 21, wherein in step (a), the machine-readable code is a bar code captured as a photograph by the device or obtained as an image by the device.

24. The removable media of claim 21, wherein in step (a), the machine-readable code is a network navigation string containing the encoded information.

25. The removable media of claim 21, including a further instruction causing the device to perform a further step of navigating to a server and obtaining an identifier to identify the contributor of the media files.
